(19) United States
(12) Patent Application Publication
(10) Pub. No.: US 2005/0210272 A1
(43) Pub. Date: Sep. 22, 2005

(54) Method and apparatus for regulating unsolicited electronic mail

(76) Inventor: Keith A. Fotta, Duxbury, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/990,944

(22) Filed: Nov. 17, 2004

Related U.S. Application Data
(60) Provisional application No. 60/520,612, filed on Nov. 17, 2003.

(51) Int. Cl. H04L 9/32

(52) U.S. Cl. 713/188; 726/22

(57) ABSTRACT

A method and apparatus for preventing unsolicited electronic mail from unwanted or illegitimate commercial entities while allowing legitimate commercial entities, subject to compliance with a regulating authority, to distribute UCE.

### RELATED APPLICATION

This application claims the benefit of U.S. Provisional Application No. 60/520,612, filed Nov. 17, 2003. The entire teachings of the above application are incorporated herein by reference.

### BACKGROUND OF THE INVENTION

As the popularity of using the Internet has increased to the point where there are currently hundreds of millions of users throughout the world, electronic mail (e-mail) has become an essential and popular method of delivering both personal and commercial messages for these users. Unfortunately, as the number of electronic mail users has increased, so has the volume of unsolicited commercial electronic mail (UCE) sent by individuals, organizations, or commercial entities interested in reaching the many users of this new communications medium. According to recent statements, while UCE, also known as Spam, accounted for an estimated seven (7) percent of all electronic mail sent in 2001, that volume has dramatically increased to over forty-five (45) percent in 2003.

From the consumer perspective, UCE has significantly reduced the convenience of reading and handling electronic mail, exposed users to unwanted or offensive electronic mail, and exposed consumers to potentially fraudulent marketing or business schemes. From the Internet Service Provider (ISP) perspective, UCE has increased the management, operational, and hardware costs of operating electronic mail or Post Office Protocol (POP) servers by forcing such ISPs to 1) add additional processing power to their existing mail servers or additional servers to handle the additional UCE, 2) add additional personnel to handle customer complaints regarding UCE, and 3) implement addition anti-Spam hardware or software to try to handle the UCE problem.

From a corporate perspective, in addition to the same operational, hardware, and management costs encountered by ISPs, UCE has impacted the efficiency of employees who are typically forced to sift through multiple electronic mail messages in order to determine which messages are relevant. According on one estimate, UCE results in a loss to corporations of $874 per year per employee.

A problem with existing anti-Spam systems is that such systems have no mechanism to clearly distinguish illegitimate or offensive UCE from legitimate UCE which may be beneficial to consumers.

Currently, typical anti-Spam products are software enhancements to existing mail clients such as Outlook or Eudora wherein the mail client examines some portion of each received electronic mail message and then determines whether to discard the message. These clients may use an internal or external black or gray list, possibly accessed via the World Wide Web (WWW), of prohibited originating e-mail domains or addresses. When e-mail is received, the client compares the originating address with its black list or gray list of prohibited domains or e-mail addresses and, if there is a match, discards the e-mail or stores the e-mail in a Spam mail folder for possible examination later. The client may also use a white list of legitimate e-mailers, populated and maintained by the client user, which can be compared with the originating address of an e-mail. If the originating address matches an entry in the white list, the e-mail is accepted.

An e-mail client may examine e-mail content to identify typical words or phrases used within most UCEs. By assigning particular values or probabilities to each word or phrase, the client can make a determination as to whether the message is acceptable or unwanted UCE. Unfortunately, such content-based or statistical UCE detection is not foolproof, resulting in false positives wherein legitimate, and potentially important, e-mails are discarded as illegitimate UCE. Furthermore, content-based detection systems typically require training and consistent tweaking from users to keep the detection scheme current, further requiring additional time and attention that could be used for more productive purposes.

Client-based anti-Spam mechanisms may also be implemented at an ISP or corporate mail server to potentially eliminate annoying UCE prior to reaching consumers or employees. Because many e-mails are channeled through an ISP or corporate mail server, a rate engine may also be utilized to detect when a certain threshold volume of a particular UCE message is sent to the mail server. Once the threshold is reached and detected by the rate engine, e.g., 1000 e-mail advertisements from a particular source, the mail server discards all further UCE from that source address. Unfortunately, the rate engine threshold is typically set at a relatively high level to prevent the blocking of legitimate e-mails from the source which allows Spamers to break up UCE into volumes that may not trigger a rate engine action.

While some of these anti-Spam systems provide a mechanism to send complaints to the Federal Trade Commission (FTC), there is no efficient, accountable, and enforceable process in which a consumer may opt out or force a commercial entity from sending unwanted UCE.

One recent proposal, in the United States, to handle UCE has been to create a national “Do-not-Spam” list, somewhat analogous to the “Do-not-call” lists used to prevent unwanted telephone solicitations. The Do-not-Spam list would require e-mail users to register their e-mail addresses if they do not want to receive UCE. Unfortunately, the nature of e-mail is significantly different than traditional land-line telephone numbers wherein the phone number is typically tied to a fix location or hardware connection. A typical consumer may have 4 or more e-mail addresses. A regulatory agency, such as the FTC, can recover and audit the phone records of a potential offending commercial entity to determine whether the entity violated U.S. Do-not-call laws. However, such auditing is significantly more difficult for Internet e-mails. Furthermore, a significant amount of UCE originates from outside the United States where non-compliant entities purposely avoid U.S. laws. A national Do-not-Spam list, if made available to such non-complying entities would effectively provide them with a comprehensive list to send UCE, while complying commercial entities would be excluded.

### SUMMARY OF THE INVENTION

Rather than blocking UCE at the e-mail client or server by a black list, or content-based statistics wherein false positives may cause valuable e-mails to be discarded, or based on client-created white lists, or server based gray list for message rate metering, all of which may not distinguish between legitimate and illegitimate UCE, the present invention provides UCE regulation by establishing a regulating authority that assigns an authenticator or authentication key to certified entities who subsequently include the authenticator in each originating UCE message. The authenticity and origin of each UCE message can be checked at a receiving message server and the appropriate action can be taken. A “receiving message server” is any system, computer, device or software application capable of receiving electronic mail or any form of electronic message, e.g., a POP mail server residing within an ISP or corporation.

Accordingly, the present invention provides an improved method and apparatus for regulating the distribution of UCE by utilizing a Regulating Authority (RA), to which commercial entities certify their existence, that enforces a process of distributing legitimate UCE from such certified commercial entities. With this arrangement, certified commercial entities provide a tangible contact point to consumers to resolve UCE complaints. A “commercial entity” may be any entity, including an individual or corporation, who transmits UCE or any unsolicited electronic mail.

The present invention provides a method and system for regulating unsolicited electronic mail by assigning a unique authentication identifier to certified commercial entities for attachment to outgoing e-mails from the entities, and by providing an authentication key for recognizing authentication identifiers of certified entities to at receiving mail servers.

The present invention also enables receiving message servers to distinguish between a legitimate UCE message sent by a certified commercial entity which contains potentially beneficial consumer advertising and an illegitimate UCE message which contains unwanted or offensive advertising material.

Furthermore, the invention provides a mechanism by which receiving message servers can authenticate and/or validate the origin of a UCE message to determine whether to discard, quarantine, or forward the UCE message. In particular, this invention provides a method wherein an explicit authenticator is included in each UCE message sent from a certified commercial entity that may be checked by an ISP or corporate receiving mail server prior to further delivery.

Another aspect of the invention provides a mechanism whereby the regulating authority provides an authenticating serial number, symmetric authentication key, or uses public key cryptography to enable the validation of legitimate or certified UCE.

The invention further establishes a certified list of legitimate commercial entities that may be trusted and held accountable by consumers via the RA.

The present invention also provides a method of blocking UCE without exposing consumer e-mail addresses to non-compliant commercial entities.

Another aspect of the present invention allows consumers to have the choice of receiving UCE from legitimate commercial entities, but also have the ability to opt out at any time, thereby blocking any further UCE from a specified commercial entity.

The present invention provides an improved method of accounting for e-mail violations by certified commercial entities because authenticated UCE messages can be traced to the offending commercial entities.

The present invention also allows any RA to regulate any type of unsolicited electronic mail regardless of whether the regulation is global or for a small group of participants.

The present invention may also enhance virus prevention by limiting or inhibiting the spread of computer viruses attached to or within UCE or other unsolicited electronic mail.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of the Unsolicited Commercial Electronic Mail Regulating system;

FIG. 2 illustrates, in accordance with an aspect of the invention, the message flow in an Unsolicited Commercial Electronic Mail Regulating system;

FIG. 3 illustrates an embodiment of a typical message with footer information including the message origin authenticator;

FIG. 4 is a functional block diagram of the message authentication process; and

FIG. 5 is a functional block diagram of the message authentication process using Public key cryptography.

### DETAILED DESCRIPTION OF THE INVENTION

Each e-mail user utilizes a client that enables the user to create, modify, delete, send, receive, or forward electronic messages to other e-mail users. These clients also include additional functionality such as an e-mail address book, ability to add file attachments, add sound and graphics, or sort messages base on different criteria, among other features. A typical e-mail address has the form: entity@location.com where “entity” may be a person's name while “location” may be the domain of an ISP or corporation

In order to send an e-mail message, the Simple Mail Transfer Protocol (SMTP) is typically used. SMTP is essentially a message transfer agent that moves a message from an e-mail user's computer to a mail server when the user clicks “send” on their client. SMTP is also an e-mail message exchange standard created by the Internet Engineering Task Force (IETF) that handles the transport of e-mail messages throughout the Internet using mail servers. SMTP functions above the Transport Control Protocol (TCP) that provides reliable message sequencing and acknowledgements to ensure that e-mail messages reach their destination successfully. Thus, mail servers that support SMTP may be referred to as SMTP mail servers. Typical SMTP servers are Sendmail (Unix), Microsoft Exchange (Microsoft OS), or Groupwise (Novell).

SMTP servers also utilize two mail server protocols known as POP and IMAP. The Post Office Protocol (POP) is a mail server protocol that handles both incoming and outgoing messages. POP mail servers typically use a store and forward technique of handling messages whereby messages are stored within the mail server until an e-mail client connects to the server and downloads the e-mail from their particular mailbox. POP servers typically use password authentication to ensure that the proper user has access to their own mail. A small company may use only one POP mail server while a large corporation or ISP may use numerous POP mail servers.

The Internet Message Access Protocol (IMAP) is another e-mail server protocol that includes the functionality of POP with additional enhancements. Unlike POP where a message is lost after download to a client, IMAP enables the e-mail user to save messages on the IMAP mail server even after download to a client. IMAP is considered the successor to POP. Any further reference to a POP server hereinafter should be considered inclusive of any SMTP, IMAP, POP, or other e-mail server capable of transferring messages between a client and mail server or between mail servers.

A typical POP mail server may also act as a relay agent to enable one mail server to forward mail to another mail server. Typically, companies or ISPs will configure their POP mail servers to only relay messages destined for their own domain, however, a POP mail server may, if configured as such, send e-mail to any destination.

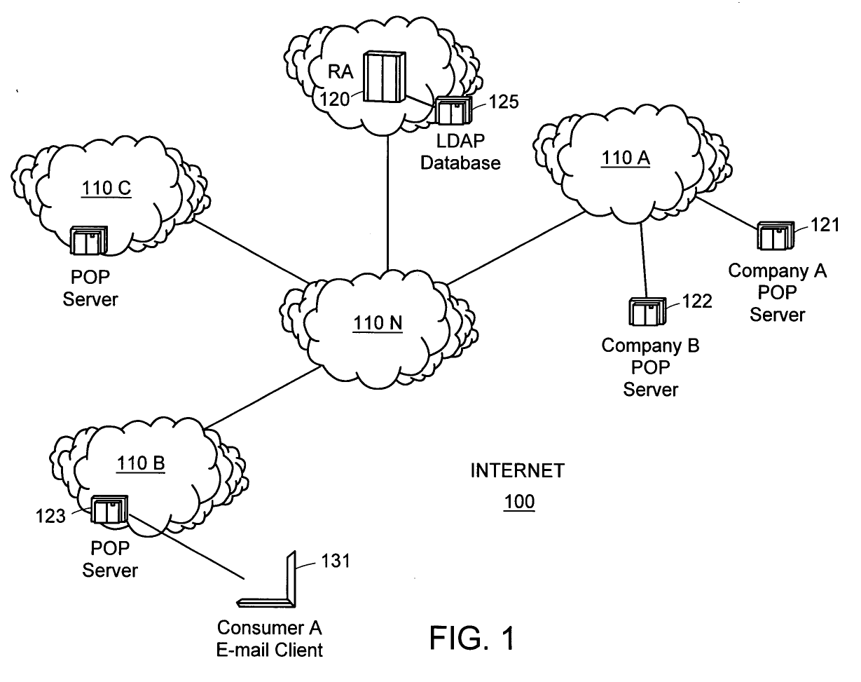

FIG. 1 shows a network 100, e.g., the Internet, as a collection of interconnected ISP networks (110a, 110b, 110c, . . . , 110n), each supporting corporations, consumers, or other organizations. Typically, these ISP networks are operated and maintained by large telecommunications companies such as Sprint, AT&T, or Verizon. Additionally, FIG. 1 depicts a Regulating Authority (RA) 120 that may reside within any of the ISP networks or its own network.

The RA 120 may be a government agency such as the FTC, a private corporation such as America On-line (AOL), a Self-Regulatory Agency (SRO) such as ICANN, or a private organization. The RA 120 is responsible for establishing UCE rules for commercial entities, such as company A or B (121, 122) depicted in FIG. 1, certifying that these commercial entities or other entities may send UCE or other electronic mail subject to the established rules, and for enforcement of such rules. The rules may be defined based on local, national, or international laws, regulations, or ordinances relating to the transmission of UCE and depend on requirements specified for the RA 120 by a controlling organization. Alternatively, the RA 120 may implement rules specified by a private organization pertaining to any form of electronic mail, not simply UCE. Thus, it is possible to have a RA 120 to oversee the use and distribution of UCE on a national or international scale or a RA 120 that only allows certain members of a small group, e.g., executive committee of a corporation or members of a flower club, to send e-mail to a particular POP server or group of POP servers.

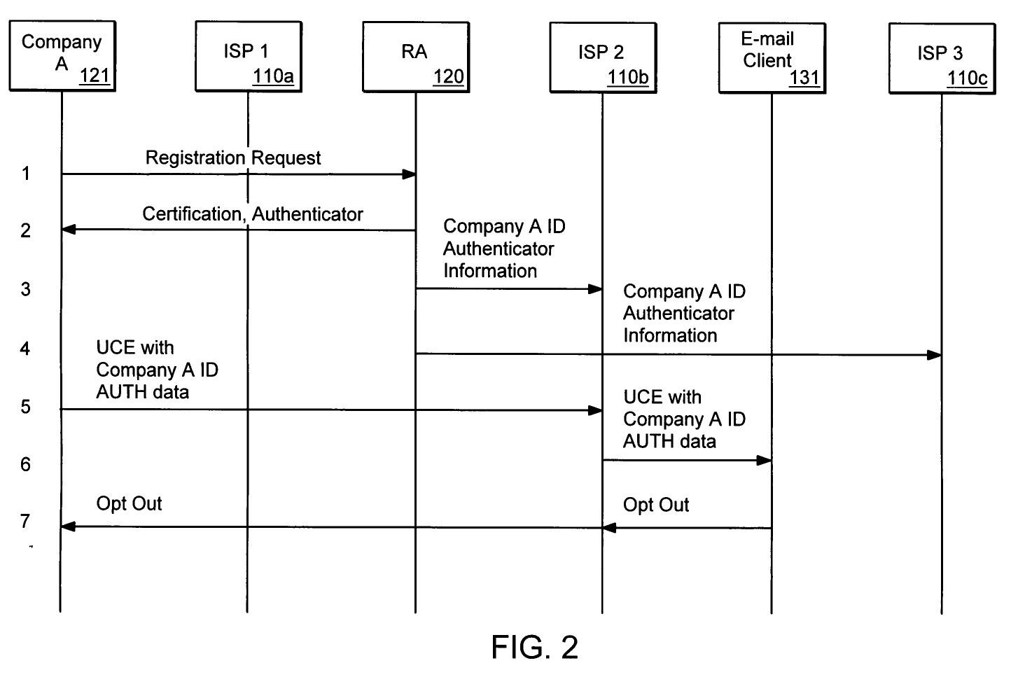

We now consider the exemplary scenario wherein a RA 120 is used to regulate the distribution of UCE throughout the Internet. A message flow is illustrated in FIG. 2. When a commercial entity, e.g., Company A 121 of FIG. 1, decides to send UCE to consumers within network 100, Company A first registers with and requests certification from the RA 120 (step 1, FIG. 2). Because the RA 120 may be enforcing rules defined by a government regulatory agency such as the FTC, the registration requirements may be relatively stringent. Company A 121 may be required to submit company name, IP address, Internet domain name, physical address, name of corporate officers, location of incorporation, a certified copy of the articles of incorporation, description of products and services provided, statement declaring a particular point of contact for UCE complaints, and potentially sign a contract wherein the company agrees to adhere to the RA rules governing UCE distribution.

Under certain circumstances, the RA 120, in the interest of reducing the potential delays for companies wishing to be certified, may allow Company A 121 to request certification from the RA 120 on-line using a WWW interface with a secure connection, via e-mail, telephone, or by conventional mail. Thus, Company A 121 may connect to a designated RA URL and provide adequate, yet less stringent, information to the RA 120, including a possible certification fee. The criteria or level of verification for certifying a commercial entity depends on the certification requirements of the RA 120.

After reviewing the request and appropriate information provided by Company A 121, the RA 120, if the information provided is satisfactory, certifies that Company A may send UCE to consumers. Furthermore, the RA 120 will create and assign an authenticator, authentication key, authentication key pair, or Public Key Certificate to Company A 121. The RA 120 then sends the certification information including authenticator to Company A 121 (step 2, FIG. 2). Depending on the level of security required to detect and regulate UCE, the RA 120 may simply generate and assign a unique serial number as the authenticator. If a higher degree of security is required, the RA 120 may generate a symmetric secret key to be used by Company A 121 to generate unique authenticators for each UCE message. Even greater security may be achieved by creating a Public Key cryptography pair and assigning the Private Key of the pair to Company A 121. Finally, the RA 120, acting as a Certificate Authority, may optionally sign Company A's Public Key, creating a Public Key Certificate. Alternatively, a commercial entity may create their Public key pair and deliver the Public key of the pair to the RA 120. The authenticator and authentication options are discussed further herein.

Depending on the configuration of the RA, the RA 120 then sends the company name, domain address, and authentication data associated with Company A to all participating receiving message servers 110b, 110c, e.g., ISP POP mail servers and corporate POP mail servers (step 3 and 4, FIG. 2). As stated above, the Authenticating information may include a unique serial number, secret key, and/or Public Key. If Public Key Certificates are used, the RA 120 need only deliver the RA's Public Key associated with the Certificates created for Company A and all other certified entities only once. Thus, the use of Public Key Certificates would eliminate the need for steps 3 and 4 of FIG. 2. However, UCE message sizes would increase to carry a Certificate within each UCE message.

The distribution of authentication information from the RA 120 to participating receiving mail servers may be provided using various mechanisms including X.500 Directory services resources such as the Lightweight Directory Access Protocol (LDAP) 125. LDAP has the advantage of potentially distributing or pushing authentication information from the RA 120 to participating receiving mail servers in near real time, i.e., performing synchronizations every several minutes. LDAP may also support a mechanism whereby participating receiving message servers pull authentication information from an RA database on a periodic basis. Additional mechanisms exist to converge LDAP with HTML to enable web-based access to the RA database or LDAP access to an RA web-based database. Company authentication information may also be distributed among multiple receiving mail servers and the RA 120 to enable one mail server to alternatively query another mail server for the authenticating information associated with a UCE message. Other more conventional means of distribution may be used such as conventional mail or e-mail.

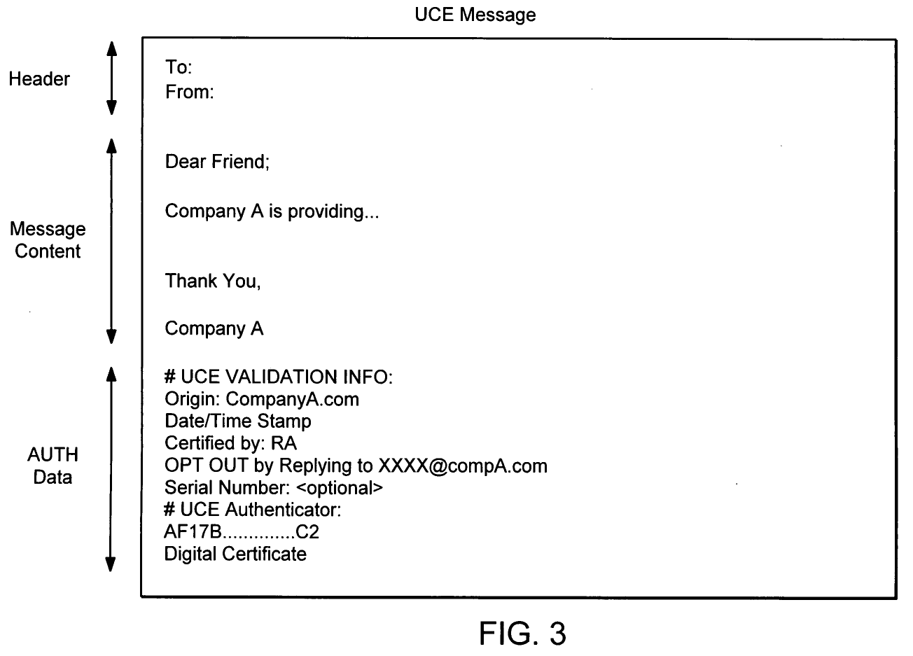

After receiving the certification response including the Authenticating information from the RA 120, Company A creates a UCE message as exemplified in FIG. 3 and sends the UCE message to the e-mail address of one or more consumers, e.g., e-mail client 131 of Consumer A (step 5, FIG. 2). The exemplary certified UCE message, as shown in FIG. 3, includes UCE Validation Information in several fields: 1) Origin field includes the commercial entity's identifying name, domain and/or e-mail address, 2) Certification field designates the particular RA such as the FTC, 3) Opt out statement includes possible contact point information such as company address, a web link or company information allowing the Consumer A to opt out from receiving additional UCE from the sending company, 4) Date/time stamp identifies when the UCE message was created and also ensures the UCE is unique, and optionally 5) a copy of the commercial entity's serial number if not included in the UCE Authenticator. Additional information may be included. When only the serial number is used for authentication, the UCE Authenticator includes the serial number. The combination of UCE Validation Information and UCE Authenticator are referred to as the Authentication (AUTH) data. Although FIG. 3 shows that the AUTH data is located in the UCE footer area, the AUTH data may be placed in any location within the UCE message, including the header if practicable. Furthermore, a delimiter, e.g., “#UCE VALIDATION INFO:”, may be used to explicitly identify the AUTH data fields to enable efficient location of the fields when a UCE message is checked.

Because Consumer A's e-mail client is connected to the POP mail server of ISP2 110b, Company A's POP mail server, using SMTP, connects with ISP2's POP mail server and sends the UCE message. Once received and depending on its rate engine settings, the ISP2 POP mail server checks the content of the UCE message sent by Company A 121.

Receiving Message Server Rate Engine

The rate engine of a receiving message server, e.g., POP mail server, may be configured to check the content of every message to determine whether the UCE Authenticator is present. If the UCE Authenticator is present, the rate engine may allow the message to pass to the client without actually checking the Authenticator. Alternatively, the rate engine may be configured to check the Authenticator of every UCE message. In another embodiment, the rate engine may only check the Authenticator of a UCE after a threshold volume of a particular UCE message is detected. Furthermore, the UCE rate engine check may be configured to occur before or after other types of e-mail checking. Typically, the rating resides in a supporting server but could also be an API call built into the receiving mail server.

Assuming the rate engine is configured to check the Authenticator after 100 UCE messages are received, once the threshold of 100 messages is reached, the receiving mail server verifies the UCE Authenticator as follows.

UCE Authentication

There are multiple methods in which UCE messages can be authenticated.

First, Company A may include a unique serial number, assigned by the RA 120, in the UCE Authenticator field. Each time a UCE message is received, a receiving message server simply checks the serial number with a list of known certified commercial entities.

This approach requires the least amount of processing by the commercial entity and receiving message server, but is the most susceptible to circumvention by an illegitimate entity who copies the serial number into their illegitimate UCE.

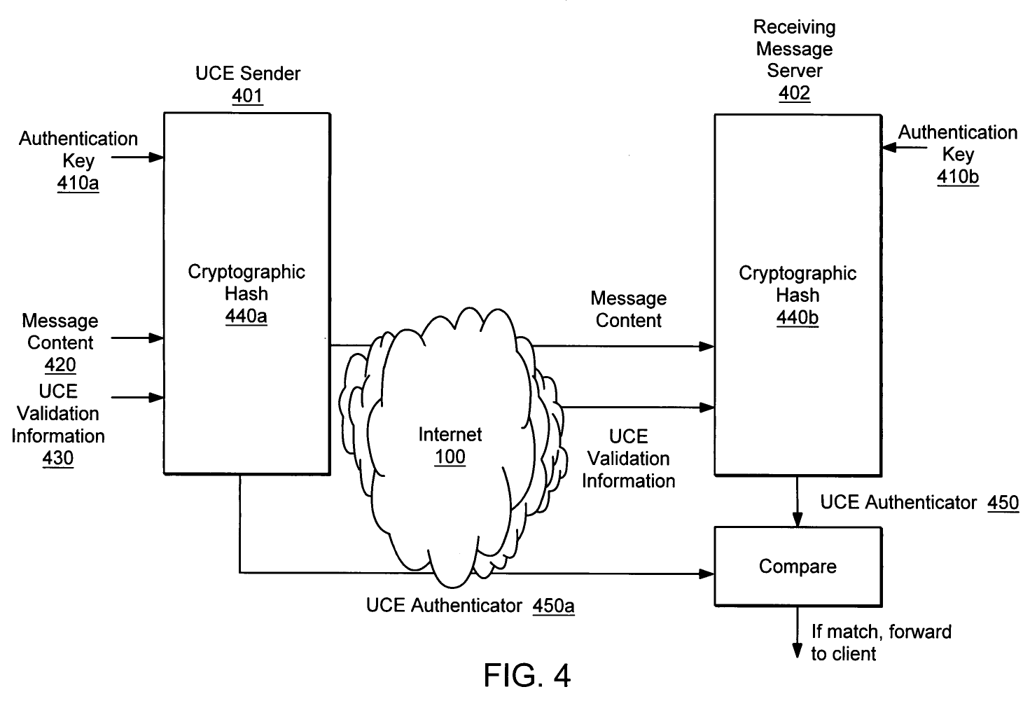

Second, as illustrated in FIG. 4, the RA 120 may issue a unique secret authentication key to each certified commercial entity that is subsequently used to generate the UCE Authenticator for each UCE message. The RA 120 distributes the unique authentication key 410b associated with each certified commercial entity to all participating receiving message servers. Preferably, additional security is used to protect the distribution such as LDAP privacy and authentication. As shown in FIG. 4, the Authentication key 410a, Message content 420, and UCE Validation Information 430 are input into a cryptographic hash function 440 such as MD5 or SHA-1 to generate the UCE Authenticator, a message digest. The UCE Validation information and UCE Authenticator are then appended to a UCE message, as shown in FIG. 3, and sent to a receiving mail server 402 via the Internet 100. Upon receipt of the message, the receiving mail server 402, using the same information received in the UCE message and the hash algorithm 440b, generates a UCE Authenticator 450a that is compared with the delivered UCE Authenticator 450b. If the UCE Authenticators match, the UCE message is accepted.

Using a secret authentication key provides superior security over the serial number method as long as the secret is protected from disclosure to potential illegitimate entities. Only an entity with the proper secret key can generate a valid UCE Authenticator.

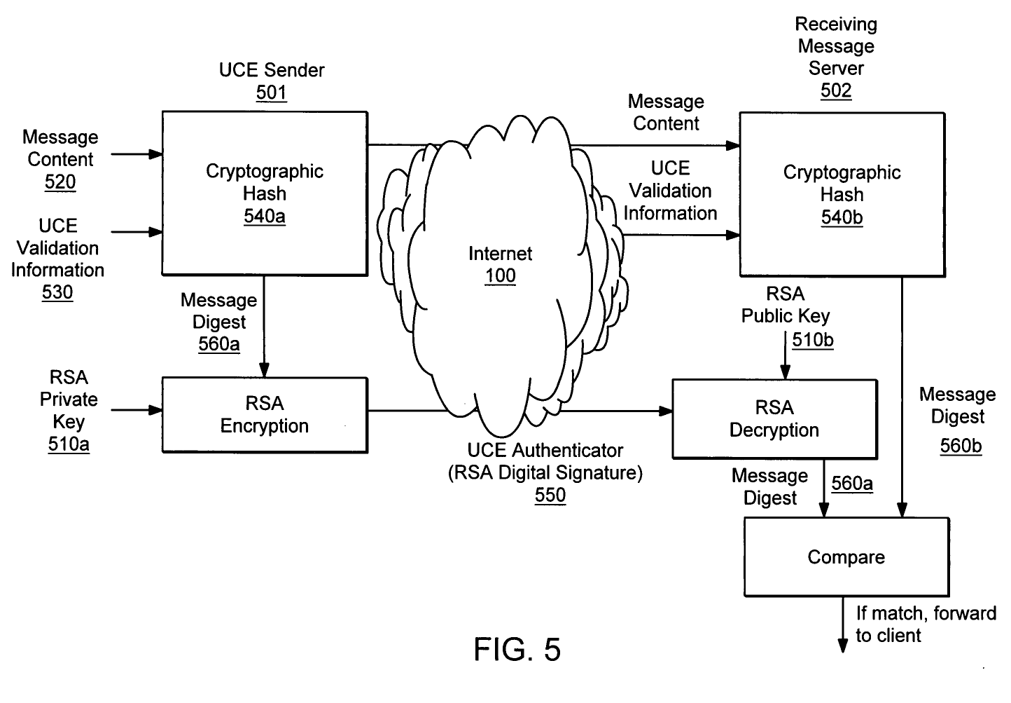

Third, instead of using a symmetric secret authentication key, a Public Key algorithm may be used to generate the UCE Authenticator. During the registration process, the RA 120 creates a Public Key pair, e.g., RSA key pair, and sends the Private key 510a to the certified commercial entity. The RA 120 then sends the Public key 510b (of the Public key pair) to all participating receiving message servers or posts the Public key 510b in a publicly accessible database. The certified commercial entity then signs each UCE message with the Private key 510a and includes the resulting digital signature in the UCE Authenticator field. Alternatively, as shown in FIG. 5, the certified commercial entity may sign the cryptographic hash 540a or digest 560a of each UCE message which is considered more efficient than directly signing the UCE message. When the UCE message is received as shown in FIG. 5, the receiving message server 502 uses the certified commercial entity's Public key 510b to check the digital signature of the UCE message digest 550 within the UCE Authenticator field. If the decrypted message digest 560a received matches the message digest 560b created by the receiving message server from the UCE message, the UCE is considered valid.

Fourth, an even more advanced method of Public Key authentication may be employed by having the RA 120 create a Public Key Certificate and send the Certificate along with the Private key back to the certified commercial entity during the registration process. In this scenario, the RA 120 need not distribute the Public key to all receiving message servers because the Public key is included in the Certificate that the commercial entity includes in every UCE message. The RA 120 must, however, distribute its own Public Key so that it can be used later by receiving message servers to check each Certificate. Thus, when a UCE message is received, the receiving message server uses the RA Public key to verify that the commercial entity Public key included in the Certificate of the UCE message is valid. Then, the receiving message entity uses the commercial entity Public Key to check the digital signature of the UCE message or UCE message digest included in the UCE Authenticator.

This approach has the advantage of eliminating the need for the RA 120 to pre-distribute the Public key of every certified commercial entity to all receiving message servers, but has the disadvantage of increasing the size of every UCE message to include the Certificate. Also, the RA 120 must now act as a Certificate Authority (CA).

Additional techniques may be employed to optimize the Public key cryptography authentication process described herein that are well known in the existing art.

If, during the UCE message authentication process, the receiving message server determines that a UCE message in not valid because the authenticator within the UCE message does not match the authenticator stored or created at the receiving message server, the receiving message server has the following configurable options: 1) silently discard the message, 2) discard with response to the originating entity including feedback or warning to stop the Spam, 3) forward offending message with incident report to the RA 120, e.g., FTC, or 4) quarantine the message for later checking or action or any combination of the above. If the receiving message server, e.g., POP mail server of ISP2, determines that the UCE message is valid, the message may be stored and is authorized for subsequent forwarding to the e-mail client of Consumer A (step 6, FIG. 2).

An important aspect of this invention is that consumers have the ability to opt out of receiving UCE messages even from certified commercial entities. Thus, certified commercial entities are not precluded from soliciting consumers unless or until a consumer explicitly requests that the solicitation end. The opt out process is intended to be convenient and clear to the consumer. Thus, if Consumer A, after receiving a legitimate UCE message from a certified commercial entity, wishes to prevent further UCE from that commercial entity, Consumer A may send an explicit e-mail, connect to the commercial entity website, call via telephone, or mail an order to prevent further UCE. If required by the RA 120, the necessary opt out contact information may be included in the UCE Validation Information. For example, Consumer A, based on opt out information provided in the UCE message of FIG. 3, may send an opt out order in an e-mail to Company A (step 7, FIG. 2).

Once an opt out order is issued by a consumer, several techniques may be employed to audit or track when the opt out occurred and any subsequent violations by a certified commercial entity. For instance, when the consumer sends an opt out order to a commercial entity, a copy may be forwarded to the RA 120, e.g., FTC, which is stored for a period of time. The RA 120 may reply to the consumer and commercial entity with a tracking number to enable recovery of the opt out notice during a subsequent disciplinary action against an offending commercial entity. Alternatively, the commercial entity may be required to send an acknowledgement to the consumer. The consumer's e-mail client may include an audit trail API or software module that stores the acknowledgement for comparison with subsequent UCE messages.

As stated previously, the RA 120 defines the criteria for revoking the certification of commercial entities that do not comply with UCE distribution rules. It should also be apparent that the receiving message server of a corporation, e.g., Company B POP mail server of FIG. 1, may check and regulate UCE messages destined for corporate employees.

While the embodiments of this invention are described within the context of Internet electronic mail, the invention is also applicable to any messaging environment such as Short Message Service (SMS) or Multimedia Message Service (MMS) within the wireless communications environment or messaging within any other electronic communications medium.

1. A method for regulating unsolicited electronic mail (e-mail) comprising:
assigning a unique authentication identifier to certified entities for attachment to outgoing e-mails from the certified entities;
providing an authentication key for recognizing authentication identifiers of certified entities to at least one receiving mail server.

2. A method of claim 1 wherein the unique authentication identifier is either a unique serial number or a secret authentication key.

3. A method of claim 1 wherein the unique authentication identifier includes a Private Key generated by a Public Key algorithm; and
the authentication key includes a corresponding Public Key to each Private Key.

4. A method of claim 1 wherein the unique authentication identifier comprises a Certified Entity Private Key generated by a Public Key algorithm, and a Regulating Authority Public Key Certificate containing the Certified Entity Public Key; and
the authentication key includes a corresponding Regulating Authority Public Key to access the Certified Entity Public Key.

5. A method of claim 1 wherein the authentication key is provided using the Lightweight Directory Access Protocol.

6. A method of claim 1 further comprising:
detecting at a receiving mail server, an authentication identifier attached to individual e-mails; and
determining appropriate action for each e-mail based on the authentication identifier attached to the e-mail and authentication key.

7. A method of claim 6 further comprising:
enabling a mail server to query another mail server or computer system zfor the authentication key.

8. A method of claim 6 wherein determining appropriation action is based on the presence of an authentication identifier.

9. A method of claim 6 further comprising:
comparing the authentication identifier to a rule set for the e-mail destination.

10. A method of claim 9 wherein determining appropriation action is based on the comparison of the unique authentication identifier to the rule set for the e-mail destination.

11. A method of claim 9 wherein the appropriate action is either to discard, quarantine, or forward the e-mail.

12. A method of claim 1 wherein the receiving mail server is either a POP mail server or an IMAP mail server.

13. A control system for regulating unsolicited electronic mail (e-mail) between an origin and destination within a network, the system comprising:
at least one list of unique authentication identifiers corresponding to certified entities for attachment to outgoing e-mails from the certified entities;
an authentication key for recognizing authentication identifiers of certified entities in at least one receiving mail server.

14. A system of claim 13 wherein the unique authentication identifier is either a unique serial number or a secret authentication key.

15. A system of claim 13 wherein the unique authentication identifier is a Private Key generated by a Public Key algorithm; and
the authentication key includes a corresponding Public Key to each Private Key.

16. A system of claim 13 wherein the unique authentication identifier comprises a Commercial Entity Private Key generated by a Public Key algorithm, and a Regulating Authority Public Key Certificate containing the Commercial Entity Public Key; and
the authentication key includes a corresponding Regulating Authority Public Key to access the Certified Entity Public Key.

17. A system of claim 13 further comprising:
a Lightweight Directory Access Protocol database for providing the authentication key to at least one receiving mail server.

18. A system of claim 13 further comprising:
at least one receiving mail server that may determine appropriate action for each received e-mail based on an authentication identifier attached to the e-mail and the authentication key.

19. A system of claim 18 wherein a receiving mail server may query another mail server or computer system for the authentication key.

20. A system of claim 18 wherein the appropriation action is based on the presence of an authentication identifier.

21. A system of claim 18 further comprising:
a processor at the receiving mailer server for comparing the authentication identifier to a rule set for the e-mail destination.

22. A system of claim 21 wherein the appropriation action is based on the comparison of the unique authentication identifier to the rule set for the e-mail destination.

23. A system of claim 21 wherein the appropriate action is either to discard, quarantine, or forward the e-mail.

24. A system of claim 13 wherein the receiving mail server is either a POP mail server or an IMAP mail server.

25. A computer processor for regulating unsolicited electronic mail (e-mail) comprising:
a first module for assigning a unique authentication identifier to certified entities for attachment to outgoing e-mails from the certified entities;
an second module for providing an authentication key for recognizing authentication identifiers of certified entities to at least one receiving mail server.

26. A processor of claim 25 further comprising:
a third module for receiving certification requests from commercial entities; and
a fourth module for approving commercial entities as certified entities.

27. A processor of claim 25 wherein the unique authentication identifier is either a unique serial number or a secret authentication key.

28. A processor of claim 25 wherein the unique authentication identifier is a Private Key generated by a Public Key algorithm; and
the authentication key includes a corresponding Public Key to each Private Key.

29. A method of claim 25 wherein the unique authentication identifier comprises a Certified Entity Private Key generated by a Public Key algorithm, and a Regulating Authority Public Key Certificate containing the Certified Entity Public Key; and
the authentication key includes a corresponding Regulating Authority Public Key to access the Certified Entity Public Key.

30. A computer readable medium having stored thereon sequences of instructions, the sequences of instructions including instruction, when executed by a processor causes the processor to perform:
assigning a unique authentication identifier to certified entities for attachment to outgoing e-mails from the certified entities;
providing an authentication key for recognizing authentication identifiers of certified entities to at least one receiving mail servers.

31. A method of regulating unsolicited electronic mail (e-mail), the method comprising:
offering a service for regulating unsolicited electronic mail (e-mail) by:
(i) assigning a unique authentication identifier to certified entities for attachment to outgoing e-mails from the certified entity; and
(ii) providing a list of authentication identifiers of certified entities to customer receiving mail servers for purposes of determining appropriate action for received e-mails based on the attached authentication identifier.
